(19) United States
(12) Patent Application Publication
(10) Pub. No.: US 2008/0259001 A1
(43) Pub. Date: Oct. 23, 2008

(54) Plasma display device and driving method thereof

(76) Inventors: Byunggeun Kim, Yongin-si (KR); Jooyul Lee, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 12/078,744

(22) Filed: Apr. 4, 2008

(30) Foreign Application Priority Data
Apr. 6, 2007 (KR) 10-2007-0034287

(51) Int. Cl. G09G 3/28

(52) U.S. Cl. 345/60

(57) ABSTRACT

A plasma display device driven by dividing one frame into a plurality of subfields includes a plasma display panel including a plurality of scan electrodes, a scan electrode driver configured to apply a falling ramp waveform to scan electrodes in a reset period, and a logic controller configured to control a maintaining section of the falling ramp waveform depending on an operational time or a temperature of the plasma display device.

### BACKGROUND OF THE INVENTION

1. Field of the Invention

Embodiments relate to a plasma display device and a driving method thereof. More particularly, embodiments relate to a plasma display device and a driving method thereof that may prevent or reduce low discharge and/or misfiring by controlling a maintaining section of a falling ramp waveform.

2. Description of the Related Art

A plasma display device is a flat display device that displays characters or images by using plasma generated by a gas discharge. The plasma display device may include a plasma display panel (PDP) on which a plurality of row electrodes and a plurality of column electrodes are formed. Discharge cells may be defined where the row electrode and the column electrode intersect. Gray scales may be expressed in the PDP by controlling discharge conditions of the discharge cells.

Generally, the plasma display device realizes the gray scale by dividing one frame into a plurality of subfields and controlling the subfields, e.g., in a time division control method. Each subfield may be divided into a reset period, an address period and a sustain period.

During the reset period, discharge cells are initialized. During the address period, discharge cells to be displayed among the discharge cells are selected. During the sustain period, discharge cells selected during the address period are discharged.

The reset period may include a rising section that rises gradually in a predetermined period and a falling section that falls gradually in a predetermined period, so as to initialize all the discharge cells and uniformly distribute wall charges in all discharge cells after address period. In particular, in the falling section of the reset period, the amount of the wall charges is reduced and simultaneously, the wall charges are uniformly distributed in the discharge cells, so that discharge may occur accurately in a next discharge period, e.g., a next address period or a next sustain period.

However, if the plasma display device is used for a long time, characteristics of a protective film of the display device may change. Thus, the discharge cells may not be initialized smoothly, and wall charges may not be uniformly distributed in the discharge cells after the reset period. Accordingly, misfiring may occur in the next discharge period.

In addition, if the plasma display device is operating under high temperatures, a reset discharge may occur excessively during the reset period, since the firing voltage of each discharge cell decreases with an increase in temperature. Thus, excessive loss of wall charges may occur, and sufficient wall charges for address discharge to be generated in the subsequent address period may not remain. Therefore, low discharge may occur in a subsequent discharge period.

### SUMMARY OF THE INVENTION

Embodiments are therefore directed to a plasma display device and a driving method thereof, which substantially overcome one or more of the problems due to the limitations and disadvantages of the related art.

It is therefore a feature of an embodiment of the present invention to provide a plasma display device and a driving method thereof that can reduce or prevent low discharge.

It is therefore another feature of an embodiment of the present invention to provide a plasma display device and a driving method thereof that may reduce or prevent misfiring.

It is therefore yet another feature of an embodiment of the present invention to provide a plasma display device and a driving method thereof that controls a maintaining section of a falling ramp waveform.

At least one of the above and other features and advantages may be realized by providing a plasma display device driven by dividing one frame into a plurality of subfields, the plasma display device including a plasma display panel including a plurality of scan electrodes, a scan electrode driver configured to apply a falling ramp waveform to scan electrodes in a reset period, and a logic controller configured to control a maintaining section of the falling ramp waveform depending on an operational time or a temperature of the plasma display device.

The logic controller may be configured to increase the maintaining section of the falling ramp waveform as the operational time increases. The plasma display device may further include a timer, connected to the logic controller, the timer configured to sense the operational time of the plasma display device and to transmit a control signal in accordance with the operational time of the plasma display device to the logic controller whenever the operational time of the plasma display device increases by a predetermined time. The logic controller may be configured to increase the maintaining section of the falling ramp waveform by a same amount from a predetermined maintaining section of the falling ramp waveform for each predetermined time increase.

The logic controller may be configured to provide an upper limit above which a length of the maintaining section of the falling ramp waveform will not be increased, regardless of an increase in operational time by the predetermined time. The predetermined time may be constant up to the upper limit.

The logic controller may be configured to increase the maintaining section of the falling ramp waveform applied to scan electrodes during the reset period of subfields that display a low gray scale among the plurality of subfields in accordance with the operational time of the plasma display device.

The logic controller may be configured to decrease the maintaining section of the falling ramp waveform in accordance with an increase in temperature of the plasma display device. The plasma display device may include a temperature sensor, connected to the logic controller, the temperature sensor configured to sense the temperature of the plasma display device and to transmit a control signal for the temperature of the plasma display device to the logic controller whenever the temperature of the plasma display device is increased by a predetermined temperature from an initial temperature.

The logic controller may be configured to provide a lower limit below which a length of the maintaining section of the falling ramp waveform will not be decreased, regardless of an increase in temperature. The predetermined temperature may be constant up to the lower limit.

The scan electrode driver may be configured to apply a main reset waveform including a rising ramp waveform to scan electrodes during a reset period of a first subfield in the plurality of subfields, and apply an auxiliary reset waveform including the falling ramp waveform to scan electrodes during reset period of remaining subfields.

At least one of the above and other features and advantages may be realized by providing a method for driving the plasma display device including a plasma display panel having a plurality of scan electrodes, the plasma display device being driven by dividing one field into a plurality of subfields, the method including sensing an operational time or a temperature of the plasma display device, controlling a maintaining section of a falling ramp waveform applied to the scan electrode during a reset period in accordance with the sensed operational time or temperature, and applying the falling ramp waveform to scan electrodes during the reset period.

Sensing may include producing a control signal in accordance with the operational time of the plasma display device whenever the operational time of the plasma display device is increased by a predetermined time. Controlling may include increasing the maintaining section of the falling ramp waveform in accordance with the control signal. Controlling may include providing an upper limit above which the maintaining section of the falling ramp waveform will not be increased, regardless of increasing operational time.

Controlling may include increasing the maintaining section of the falling ramp waveform in accordance with the operational time of the plasma display device in subfields that display a low gray scale in the plurality of subfields.

Applying may include applying a main reset waveform including a rising ramp waveform to scan electrodes during a reset period of a first subfield of the plurality of subfields, and applying the falling ramp waveform to scan electrodes during reset periods of remaining subfields.

Sensing may include producing a control signal whenever the temperature of the plasma display device is increased by a predetermined temperature from an initial temperature. Controlling may include decreasing the maintaining section of the falling ramp waveform from a predetermined maintaining section of the falling ramp waveform in accordance with the control signal. Controlling may include providing a lower limit below which the maintaining section of the falling ramp waveform will not be decreased, regardless of increasing temperature.

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 illustrates a perspective view of an example of a plasma display panel of a plasma display device;

FIG. 2 illustrates a schematic block diagram of a plasma display device according to an exemplary embodiment of the present invention;

FIG. 3 illustrates a waveform diagram as an example of a driving waveform for use in a driving method of the plasma display device of FIG. 2;

FIGS. 4A and 4B illustrate waveform diagrams detailing a change of a falling section of a reset period depending on an operational time of a plasma display device in the driving method of the plasma display device according to an exemplary embodiment of the present invention;

FIG. 5 illustrates a schematic block diagram of a plasma display device according to another exemplary embodiment of the present invention;

FIGS. 6A and 6B illustrate waveform diagrams detailing the change of a falling section of a reset period depending on the increase of temperature of a plasma display device in the driving method of the plasma display device according to another exemplary embodiment of the present invention; and

FIG. 7 illustrates a graph of the relationship between the temperature of the plasma display device and a maintaining section of the falling ramp waveform.

### DETAILED DESCRIPTION OF THE INVENTION

Korean Patent Application No. 10-2007-0034287, filed on Apr. 6, 2007, in the Korean Intellectual Property Office, and entitled: “Plasma Display Device and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

Wall charges mentioned in the following description mean charges formed and accumulated on a wall (e.g., a dielectric layer) close to an electrode of a discharge cell. A wall charge will be described as being “formed” or “accumulated” on the electrodes, although the wall charges do not actually touch the electrodes. Further, a wall voltage means a potential difference formed on the wall of the discharge cell by the wall charge.

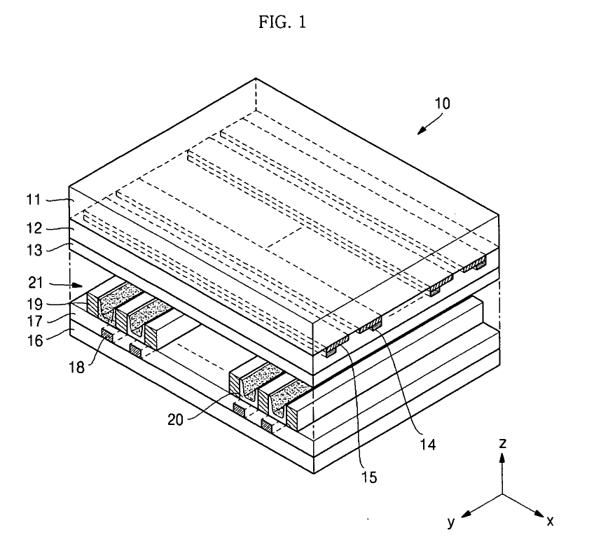

FIG. 1 illustrates a perspective view of a plasma display panel (PDP) 10 of a plasma display device according to an embodiment of the present invention.

Referring to FIG. 1, the PDP 10 may include an upper substrate 11 and a lower substrate 16.

A plurality of scan electrodes 14 and sustain electrodes 15 may be arranged in a predetermined spaced relationship on the upper substrate 11, e.g., along an x-direction. A surface of the upper substrate 11 may be covered by an upper dielectric layer 12 and a protective film 13. The protective film 13 may be formed of, e.g., magnesium oxide (MgO). The protective film 13 may not only protect the upper dielectric layer 12, but may also contribute to electron emission.

A plurality of address electrodes 18 may be arranged in a direction perpendicular to the scan electrode 14 and the sustain electrode 15 on the lower substrate 16, e.g., in the y-direction. A surface of the lower substrate 16 may be covered by a lower dielectric layer 17. A plurality of barrier ribs 19 may be arranged in a predetermined spaced relationship in the direction parallel to the address electrode 18 on the surface of the lower dielectric layer 17, e.g., in the y-direction. Phosphor layers, e.g., R, G, and B phosphor layers, may be formed repetitively on each barrier rib 19. Discharge may be generated in a discharge space 21 formed by the barrier ribs 19 and the protective film 13. In particular, a discharge cell may be formed at the region where the scan electrode 14, the sustain electrode 15 and the address electrode 18 intersect each other.

The PDP 10 illustrated in FIG. 1 is merely an example, and embodiments of the present invention are not limited thereto. For example, in the PDP 10, the barrier ribs 19 are formed as open with equal spacing, but may have various alternative configurations, e.g., closed type, waffle type or honeycomb type. Further, in the PDP 10, only one phosphor layer 20 corresponds to one address electrode 18, but the R, G, B phosphor layers 20 may be formed to correspond respectively to one address electrode 18.

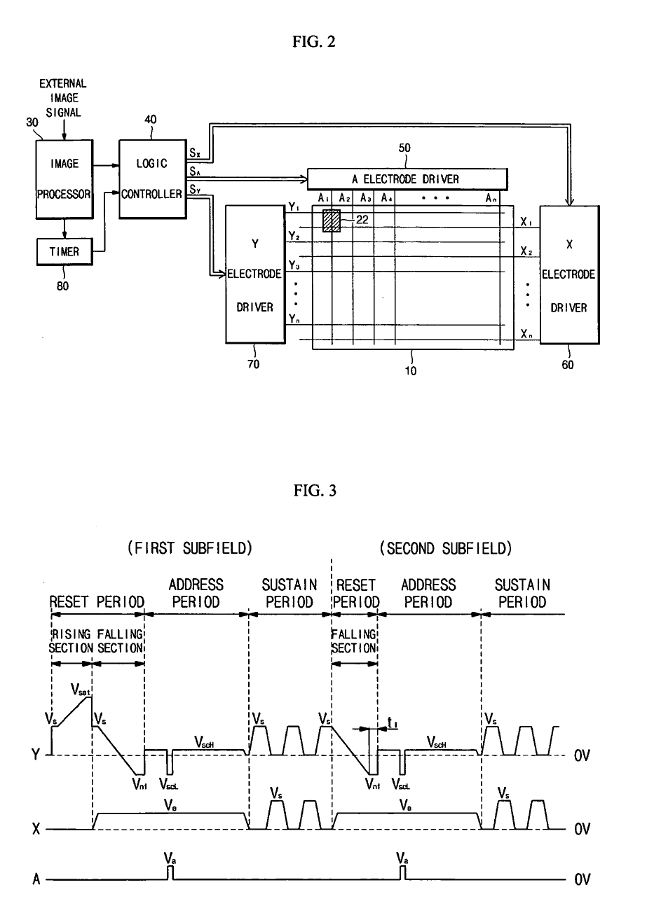

FIG. 2 illustrates a schematic block diagram of a plasma display device according to one exemplary embodiment of the present invention.

The plasma display device may include the PDP 10, an image processor 30, a logic controller 40, an address electrode driver 50, a sustain electrode driver 60, a scan electrode driver 70, and a timer 80.

As described above, the PDP 10 may include a plurality of scan electrodes 14 and sustain electrodes 15 arranged in row direction and a plurality of address electrodes 18 arranged in column direction crossing the scan electrodes 14 and the sustain electrodes 15. In FIG. 2, the plurality of scan electrodes are illustrated as (Y₁ to Yn) (hereinafter referred to as “Y electrode”), and the plurality of sustain electrodes are illustrated as (X1 to Xn) (hereinafter referred to as “X electrode”), and the plurality of address electrodes are illustrated as (A₁ to Aₘ.) (hereinafter referred to as “A electrode”).

Generally, the X electrodes (X1 to Xn) may be parallel to the Y electrodes (Y₁ to Yn), and the X electrodes (X1 to Xn) and the Y electrodes (Y₁ to Yn) may orthogonally cross the A electrodes (A₁ to Aₘ). Discharge cells 22 may be defined at intersection the A electrodes (A₁ to Aₘ), the X electrodes (X1 to Xn), and the Y electrodes (Y₁ to Yn).

The image processor 30 may convert an external image signal to an internal image signal that is displayable on the PDP 10, and may output the internal image signal to the logic controller 40.

The logic controller 40 may output various drive control signals (S_{A}, S_{X}, S_{Y}), that are converted to be applicable for the internal image signal, to the A electrode driver 50, the X electrode driver 60, and the Y electrode driver 70, respectively. The logic controller 40 may control an applying time of a falling ramp waveform being applied to the Y electrode during a reset period depending on a length of time for which the plasma display device has been used, i.e., an operational time. The logic controller 40 may drive one frame by dividing each frame into a plurality of subfields. Each subfield may include a reset period, an address period and a sustain period in expression of changes over time.

The A electrode driver 50 may receive the A electrode drive control signal S_{A} from the logic controller 40 and apply a display data signal for selecting the discharge cell to be displayed to each A electrode. The X electrode driver 60 may receive the X electrode drive control signal S_{X} from the logic controller 40 and apply a drive voltage to the X electrode. The Y electrode driver 70 may receive the X electrode drive control signal S_{Y} from the logic controller 40 and apply a drive voltage to the Y electrode.

The timer 80 may measure the operational time of the plasma display device, and may be connected between the image processor 30 and the logic controller 40. The timer 80 may transmit a control signal for the measured time to the logic controller 40.

In particular, the timer 80 may measure a total operational time of the plasma display device. For example, the timer 80 may measure the total operational time from an initial use to the present by continually summing up the time from power-on to power-off. The timer 80 may transmit a control signal for the operational time of the plasma display device to the logic controller 40 whenever the operational time is increased by a predetermined time, e.g., 190 to 210 hours, for example, 200 hours.

The logic controller 40 may control an applying time of the falling ramp waveform of the reset period depending on the control signal. That is, the logic controller 40 may control the maintaining section of the falling ramp waveform to be increased by, e.g., 0.5 to 1.5 μs, for example, 1 μs, from a predetermined maintaining section of the falling ramp waveform whenever the operational time of the plasma display device has increased by the predetermined time. The maintaining section of the falling ramp waveform refers to the section maintaining the lowest voltage of the reset period, e.g., a voltage V_{nf} in FIG. 3, also referred to as a flat section of the falling ramp waveform.

However, if the maintaining section of the falling ramp waveform is increased too much, discharge problems may occur. Thus, the maintaining section of the falling ramp waveform may be controlled to be within a range that does not cause discharging problems. For example, the maintaining section of the falling ramp waveform may have an upper limit of about 20 to 30 μs, e.g., about 25 μs, from the predetermined maintaining section of the falling ramp waveform. Accordingly, the logic controller 40 may control the maintaining section of the falling ramp waveform to not increase the maintaining section of the falling ramp waveform by more than the upper limit above the predetermined maintaining section. For example, if the upper limit is about 25 μs above the predetermined maintaining section, and the maintaining section is increased by about 1 μs for every increase of about 200 hours, the maintaining section may be increased over up to 5,000 hours, after which the maintaining section will not increase further. The predetermined time, the incremental increase in the maintaining section, and the upper limit are not limited to the specific examples herein, but may be varied depending on the particulars of the PDP. Further, while the predetermined time and the incremental increase are indicated as being constant for the operational time range, they may be variable in accordance with operational parameters of the PDP.

As described above, the logic controller 40 of the plasma display device may smoothly initialize the discharge cells and make the distribution of the wall charges uniform in the reset period by increasing the maintaining section of the falling ramp waveform even if the protective film, e.g., MgO, is degraded due to the increase of the use time of the plasma display device. Accordingly, misfiring that occurs as the use time of the plasma display device increases may be decreased or prevented.

FIG. 3 illustrates a waveform diagram an example of a drive waveform in a method for driving the plasma display device of FIG. 2.

In FIG. 3, the drive waveform shown includes two subfields of the plurality of subfields forming one frame. Hereinafter, for the convenience, only the drive waveform applied to Y electrode, X electrode, and A electrode that form one discharge cell will be explained.

In the drive waveform for driving the plasma display device according to one exemplary embodiment of the present invention, one frame may be divided into a plurality of subfields, e.g., 8 to 11 subfields. Each subfield may include a reset period, an address period, and a sustain period.

During the reset period, discharge cells are initialized. During the reset period of the first subfield, a reset waveform (hereinafter referred to as “main reset waveform”) that produces wall charges on all the discharge cells and erases the wall charges is applied. During the reset period of subfields subsequent to the first subfield, a reset waveform (hereinafter referred to as “auxiliary reset waveform”) that erases only the wall charges of the discharge cells in which discharging has occurred in the previous subfield by erasing the wall charges without producing wall charges on the discharge cells is applied. During the address period, discharge cells to be displayed among the discharge cells are selected. During the sustain period, discharge cells selected during the address period are discharged.

The main reset waveform applied during the reset period of the first subfield may include a rising section and a falling section. In the rising section, a rising ramp waveform applied to the Y electrode may gradually rise to a Vₛₑₜ voltage beyond the firing voltage from a Vₛ voltage, while the X electrode is maintained at a reference voltage, e.g., 0 V. Then, a weak reset discharge occurs respectively between the A electrode and the X electrode, and the Y electrode. Thus, negative (−) wall charges may be formed on the Y electrode, and positive (+) wall charges may be formed on the A electrode and X electrode simultaneously.

In the falling section of the main reset waveform, a falling ramp waveform applied to the Y electrode may gradually fall to a voltage V_{nf} from the voltage Vₛ, while the X electrode is maintained at a voltage Vₑ. Then, while the voltage of the Y electrode decreases, a weak reset discharge occurs between the Y electrode and the X electrode, and between the Y electrode and the A electrode. Thus, simultaneously, the negative (−) wall charges formed on the Y electrode and the positive (+) wall charges formed on the A electrode and X electrode are erased. Herein, the wall charges may not be completely erased, but may be uniformly distributed on the entire area of the discharge cells and simultaneously, the number of the wall charges may be decreased. Further, in the falling section, the Y electrode may be maintained at the voltage V_{nf} during the period of time before start of the address period, hereinafter referred to as the “maintaining section” of the falling ramp waveform. The maintaining section of the falling ramp waveform may last for a predetermined period of time, e.g., in a range of about 35 to 45 μs.

During the address period of the first subfield, a scan pulse having a voltage V_{scL} may be applied to the Y electrode and an address pulse having a voltage Vₐ may be applied to the A electrode for selecting discharge cell to be turned on. The Y electrode that is not selected may be biased to a voltage V_{scH} higher than the voltage V_{scL} and the reference voltage, e.g., the voltage 0 V, may be applied to the A electrode of the cell that is not turned on. Then, address discharging occurs due to the difference between the voltage Vₐ and the voltage V_{scL}, and the wall voltage due to the wall charges formed on the A electrode and the Y electrode. As a result, positive (+) wall charges are formed on the Y electrode and negative (−) wall charges are formed on the X electrode. Further, negative (−) wall charges are also formed on the A electrode.

During the sustain period, a sustain pulse alternately having a high level voltage (voltage Vs in FIG. 3) and a low level voltage (0V voltage in FIG. 3) may be applied to the plurality of X electrodes and a plurality of Y electrodes, so as to sustain discharge the light emitting cells. The sustain pulse applied to the X electrodes may have a reverse phase of the sustain pulse applied to the Y electrodes. The sustain pulse may alternate a difference between the voltages of the Y electrode and the X electrode to be the voltage Vₛ and the voltage −Vₛ. Pulses applied to the Y electrode and the X electrode may have the same width.

If the wall voltage has been formed between the Y electrode and the X electrode by address discharging during the previous address period, the sustain discharging occurs at the Y electrode and the X electrode due to the wall voltage and the voltage Vₛ. Applying the voltage Vₛ to the Y electrode and to the X electrode may be repeated in accordance with a weight value the subfield is to display.

When the sustain period of the first subfield is completed, the second subfield is started.

During the reset period of the second subfield, the auxiliary reset waveform is applied. The auxiliary reset waveform may include only a falling section. In the falling section of the auxiliary reset waveform, a falling ramp waveform applied to the Y electrode may gradually fall to the voltage V_{nf} from the voltage Vₛ applied to the Y electrode in the sustain period of the first subfield. When a sustain discharge has occurred in the sustain period of the first subfield, because negative (−) wall charges are formed on the Y electrode and positive (+) wall charges are formed on the X electrode and A electrode, weak discharges occur, as in the falling section of the main reset period of the first subfield, when the total of voltage of the Y electrode and the wall voltage in the discharge cells exceeds the firing voltage during gradually decrease of the voltage of the Y electrode. Because the voltage V_{nf} of the Y electrode in the auxiliary reset waveform is the same as the voltage V_{nf} of the falling section of the main reset waveform, the condition of wall charges after completion of the falling section of the second subfield may be substantially the same as the condition of wall charges after completion of the falling section of the main reset waveform in first subfield.

Because the weak discharge does not occur during the reset period of subsequent subfields in discharge cells in which sustain discharge has not occurred in the sustain period of the previous subfield, the condition of the wall charges on the discharge cells after completion of the auxiliary reset waveform is the same as the condition of wall charges after completion of the main reset waveform. Thus, since the wall voltage formed on the discharge cells after completion of the reset period is near the firing voltage, discharging does not occur when the voltage of the Y electrode is decreased to the voltage V_{nf}. Therefore, because discharging does not occur in the reset period of the second subfield, the condition of wall charges set in the reset period of the first subfield is maintained.

As described above, in subfields in which the reset period includes only the falling section, i.e., the auxiliary reset waveform, reset discharge occurs when the sustain discharge has occurred in the previous subfield, but does not occur when the sustain discharge has not occurred.

As the address period and the sustain period of the second subfield are the same as the first subfield, detailed explanation thereof will not be repeated. Again, during the sustain period of the second subfield, the sustain voltage Vₛ may be applied to the Y electrode and the X electrode with reverse phase a number of times corresponding to the weight value that the corresponding subfield displays. The same waveforms used in the second subfield may be applied in remaining subsequent subfield. The same waveform used in the first subfield may be applied in an optional subfield.

The maintaining section of the falling ramp waveform of the auxiliary reset waveform applied to the second subfield may be designed to increase in proportion to an operational time of the plasma display device. When the plasma display device has been used for a long time, the emission of secondary electrons may decrease due to changes in the property of the protective film of the plasma display device, so that the initialization of the discharge cells by erasing wall charges may not be smoothly performed and misfiring may occur in a subsequent address period or a subsequent sustain period. Therefore, in the driving method of the plasma display device according to the one exemplary embodiment of the present invention, the wall charges of the discharge cells may be sufficiently erased by increasing the maintaining section of the falling ramp waveform, i.e., making the maintaining section of the falling ramp waveform longer, misfiring may be reduced or eliminated in subsequent address or sustain periods, increasing the operational life of the plasma display device.

An initial maintaining section of the falling ramp waveform of the auxiliary reset waveform applied in the reset period in the second subfield is indicated as “t₁”, as shown in FIG. 3. If the maintaining section is longer, the falling ramp waveform becomes longer, and if the maintaining section is shorter, the falling ramp waveform becomes shorter.

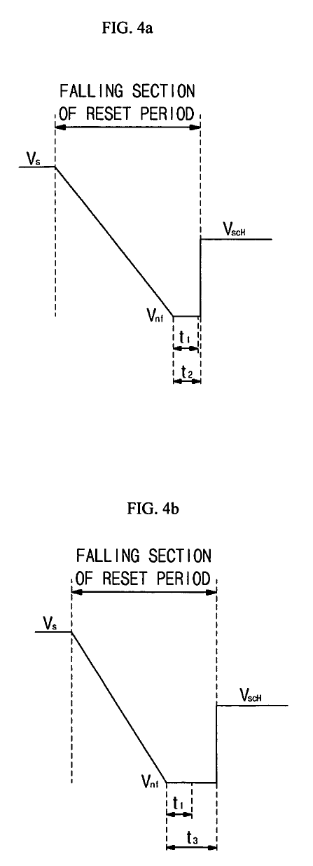

FIGS. 4A and 4B illustrate waveform diagrams detailing the change of the falling section of the reset period depending on time of use of the plasma display device. FIG. 4A illustrates a waveform diagram detailing the falling ramp waveform of the auxiliary reset waveform applied when plasma display device has been used for about 200 hours. FIG. 4B illustrates a waveform diagram detailing the falling ramp waveform applied of the auxiliary reset waveform when the plasma display device has been used for about 5,000 hours.

Referring to FIG. 4A, when the timer 80 of the plasma display device senses that the plasma display device has been used for about 200 hours, the timer 80 may transmit a control signal to the logic controller 40 indicating that the plasma display device has been used for about 200 hours. Then, the logic controller 40 may increase the maintaining section of the falling ramp waveform of the auxiliary reset waveform by about 1 μs from the predetermined maintaining section t₁ of the falling ramp waveform, i.e., to “t₂”.

Although not shown in FIG. 4A, the logic controller 40 may increase the maintaining section of the falling ramp waveform of the auxiliary reset waveform by about 0.5 μs to 1.5 μs, e.g., by about 1 μs, whenever the plasma display device has been used by an additional 190 to 210 hours, e.g., at each 200 hour increment. Accordingly, wall charges may be sufficiently erased by increasing the maintaining section of the falling ramp waveform of the auxiliary reset waveform by about 1 μs whenever the operational time increases by about 200 hours. Therefore, the plasma display device according to the one exemplary embodiment of the present invention may prevent or reduce insufficient erasure of wall charges in the auxiliary reset period as the operational time of plasma display device increases.

Next, as shown in FIG. 4B, when the timer 80 of the plasma display device senses that the operational time of the plasma display device is about 5,000 hours, e.g., the operational time has exceeded 200 hours, 400 hours, . . . 4,500 hours, the timer 80 may transmit a control signal to the logic controller 40 that the operational time of the plasma display device is about 5,000 hours. Then, the logic controller 40 may increase the maintaining section of the falling ramp waveform of the auxiliary reset waveform to within about 20 to 30 μs, e.g., by about 25 μs, from the predetermined maintaining section t₁ of the falling ramp waveform, i.e., to “t₃”. When the logic controller 40 of the plasma display device increases the maintaining section of the falling ramp waveform by 1 μs from the predetermined maintaining section t₁ of the falling ramp waveform whenever the operational time increases by each 200 hours, the maintaining section t₃ of the falling ramp waveform may be increased by about 25 μs from the predetermined maintaining section t₁ when the operational time becomes about 5,000 hours. Of course, the timer 80 may transmit the control signal to the logic controller 40 for each instance when the operational time is increased by about 200 hours before operational time becomes 5,000 hours.

A lifetime of a general plasma display device is 60,000 hours. However, if the maintaining section of the falling ramp waveform is increased continually until operational time becomes 60,000 hours, discharging problems may arise. Therefore, an increase in the maintaining section of the falling ramp waveform may be limited by the upper limit, e.g., about 25 μs, above the predetermined maintaining section t₁ of the maintaining section of the falling ramp waveform. Accordingly, the logic controller 40 may control the maintaining section of the falling ramp waveform so as not to be further increased once the upper limit, here reached at about 5,000 hours, has been exceeded.

In addition, in FIGS. 4A and 4B, while the maintaining section of the falling ramp waveform is illustrated as being controlled in the reset period of the second subfield, the maintaining section may also be controlled in the reset period of subsequent subfields, e.g., a third subfield and a fourth subfield for displaying a low gray scale. This is to prevent in advance misfiring by controlling the maintaining section of the falling ramp waveform in the previous subfield. Therefore, misfiring occurring in previous subfields may be prevented from affecting discharging in subsequent subfields.

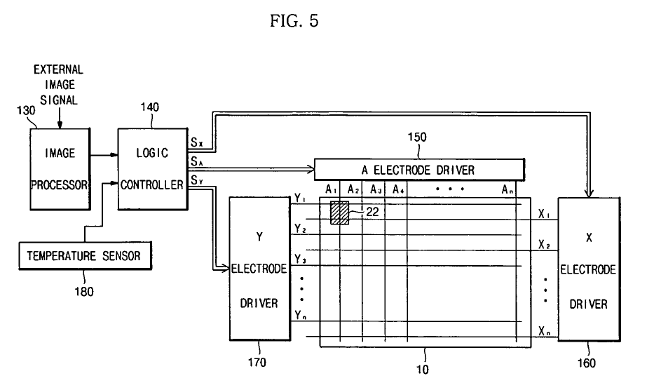

FIG. 5 illustrates a schematic block diagram of a plasma display device according to another exemplary embodiment of the present invention.

The plasma display device may include the PDP 10, an image processor 130, a logic controller 140, an address electrode driver 150, a sustain electrode driver 160, a scan electrode driver 170, and a temperature sensor 180.

The plasma display device according to another exemplary embodiment of the present invention may include the same elements as the plasma display device according to the one exemplary embodiment of the present invention illustrated in FIG. 1, except that the temperature sensor 180 is provided in FIG. 5 instead of the timer 80 shown in FIG. 1. Accordingly, explanation about the same elements as the previous exemplary embodiment will not be repeated. The temperature sensor 180 and the logic controller 140 for performing a different operation than the logic controller 40 of FIG. 2 will be explained in detail below.

The temperature sensor 180 may be mounted on a logic board (not shown) provided with the logic controller 140. The temperature sensor 180 may sense the temperature of the plasma display device and transmit a control signal for the temperature of the plasma display device to the logic controller 140. For example, the temperature sensor 180 may repeatedly transmit the control signal to the logic controller 140 every time the temperature of the plasma display device is increased by a predetermined temperature, e.g., about 4 to 6° C., such as about 5° C., during operation of the plasma display device.

Then, the logic controller 140 may control the falling section of the auxiliary reset waveform in the drive waveforms of FIG. 3 in accordance with the control signal received from the temperature sensor 180. For example, the logic controller 140 may decrease the maintaining section of the falling ramp waveform by a predetermined time period, e.g., about 3 to 4 μs, such as by about 3.6 μs, whenever the temperature of the plasma display device is increased by a predetermined amount, for example, about each 5° C. from an initial temperature, e.g., about 15 to 25° C., such as about 20° C.

Accordingly, the logic controller 140 of the plasma display device according to another exemplary embodiment of the present invention may reduce an excessive reset discharge in the reset period by decreasing the maintaining section of the falling ramp waveform to compensate for a decrease in the firing voltage of each discharge cell as the temperature of the plasma display device increases. Therefore, a low discharge may be prevented in subsequent address discharge or sustain discharge by reducing the excessive loss of the wall charges in the reset period.

However, if the logic controller 140 decreases the maintaining section of the falling ramp waveform continually for every temperature increase of the plasma display device of about 5° C. from the initial temperature, misfiring may occur under excessive temperatures. Therefore, the logic controller 140 may provide a lower limit below which the maintaining section of the falling ramp waveform may not be decreased, e.g., about 36 to 48 μs, such as about 43.2 μs, from a predetermined maintaining section of the falling ramp waveform. Accordingly, when the predetermined temperature is about 5° C., the predetermined time period is about 3.6 μs, and the lower limit is about 43.2 μs, when the temperature of the plasma display device becomes about 80° C., the logic controller 140 may prevent the maintaining section of the falling ramp waveform from further decreasing, even when the temperature of the plasma display device increases over 80° C. The predetermined temperature, predetermined time period, and the lower limit are not limited to the specific examples given above, but may be adjusted depending on the PDP. Further, while the predetermined temperature and predetermined time period are indicated as being constant for the temperature range, they may be variable in accordance with operational parameters of the PDP.

As described above, the logic controller 140 of the plasma display device according to another exemplary embodiment of the present invention does not decrease any more the maintaining section of the falling ramp waveform under the condition of excessive temperature over 80° C., to thereby prevent the misfiring in subsequent address discharge or sustain discharge.

A method for driving the plasma display device according to another exemplary embodiment of the present invention will be explained by applying the drive waveform of FIG. 3.

The plasma display device according to another exemplary embodiment of the present invention is driven by the drive waveform in which one frame is divided into a plurality of subfields, each subfield includes a reset period, an address period and a sustain period in FIG. 3.

The driving method of the plasma display device according to another exemplary embodiment of the present invention is designed to decrease the maintaining section of the falling ramp waveform, i.e., to make the maintaining section of the falling ramp waveform shorter, in accordance with the increase of the temperature of the plasma display device. This is to prevent the low discharge in subsequent address discharge or sustain discharge by reducing erasing of the wall charges by the reset discharge in the reset period because when the temperature of the plasma display device increases, the firing voltage of the discharge cell is lowered so that the loss of the wall charges increases. However, because misfiring may also occur if the maintaining section of the falling ramp waveform is continually decreased under the temperature over excessive temperature in the case that the temperature of the plasma display device increases continually, the reduction of the maintaining section of the falling ramp waveform is limited over an excessive temperature in the method for driving the plasma display device according to another exemplary embodiment of the present invention.

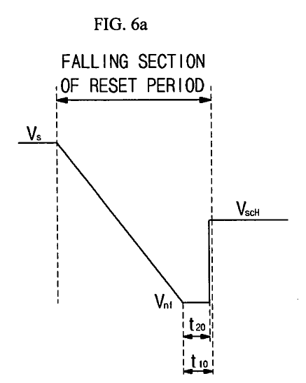

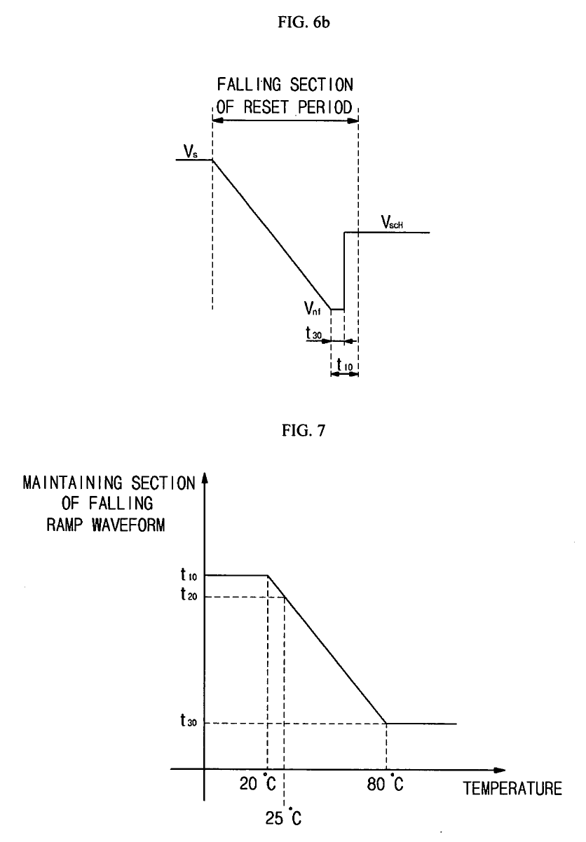

FIGS. 6A and 6B illustrates waveform diagrams detailing the change of the maintaining section of the falling ramp waveform in accordance with a change in temperature of the plasma display device in the method for driving the plasma display device according to another exemplary embodiment of the present invention. FIG. 7 illustrates a graph of the relationship between the temperature of the plasma display device and the maintaining section of the falling ramp waveform.

FIG. 6A illustrates a waveform diagram of the maintaining section of the falling ramp waveform applied in the auxiliary reset waveform when the temperature of the plasma display device is about 25° C. FIG. 6B illustrates a waveform diagram of the maintaining section of the falling ramp waveform applied in the auxiliary reset waveform when the temperature of the plasma display device is about 80° C.

In the driving method of the plasma display device according to another exemplary embodiment of the present invention, the maintaining section of the falling ramp waveform applied in the auxiliary reset waveform may be decreased when the temperature of the plasma display device rises from about 20° C. to about 80° C. For example, the maintaining section of the falling ramp waveform may be decreased by about 3 to 4 μs, e.g., by about 3.6 μs, whenever the temperature of the plasma display device is increased by about 4 to 6° C., e.g., by about 5° C. from a starting temperature of about 15 to 25° C., e.g., about 20° C.

For example, if the temperature sensor 180 senses that the temperature of the plasma display device is about 25° C. (that is, the temperature increased by about 5° C. from an initial temperature of about 20° C.), the logic controller 140 may control the maintaining section t₂₀ of the falling ramp waveform of the auxiliary reset waveform to be decreased by about 3.6 μs from a predetermined maintaining section t₁₀ of the falling ramp waveform. Herein, the predetermined the maintaining section t₁₀ of the falling ramp waveform is to indicate the maintaining section of the falling ramp waveform applied during the falling ramp waveform of the reset period when the temperature of the plasma display device is below about 20° C.

If the temperature of the plasma display device is about 80° C., i.e., the temperature of the plasma display device increases by about 60° C. from 20° C., the logic controller 140 may control the maintaining section t₃₀ of the falling ramp waveform applied in the falling ramp waveform of the reset period of the second subfield to be decreased by about 43.2 μs from the predetermined maintaining section t₁₀ of the falling ramp waveform, as shown in FIG. 6B. In this case, if the maintaining section of the falling ramp waveform is decreased by about 36 to 48 μs, e.g., by about 43.2 μs from the predetermined maintaining section t₁₀ of the falling ramp waveform, the logic controller 140 may prevent the maintaining section of the falling ramp waveform from further decreasing even when the temperature of the plasma display device increases. This is because the low discharge occurs on the contrary if the maintaining section of the falling ramp waveform is continually decreased from the predetermined maintaining section of the falling ramp waveform.

Referring to FIG. 7, considering the relationship between the temperature of the plasma display device and the maintaining section of the falling ramp waveform, when the temperature of the plasma display device is below about 20° C., the predetermined maintaining section of the falling ramp waveform is maintained at t₁₀, and when the temperature of the plasma display device is within the range of about 20° C. to 80° C., the maintaining section of the falling ramp waveform is decreased to t₃₀ via t₂₀ from t₁₀, and when the temperature of the plasma display device is over about 80° C., the maintaining section of the falling ramp waveform is maintained at t₃₀.

Accordingly, in the driving method of the plasma display device according to another exemplary embodiment of the present invention, the low discharge can be prevented by decreasing gradually the maintaining section of the falling ramp waveform when the temperature of the plasma display device is within the range of about 20° C. to 80° C., and the misfiring can be prevented when the temperature of the plasma display device is about 80° C. or higher.

In FIGS. 6A and 6B, the maintaining section of the falling ramp waveform is illustrated to be controlled in the reset period of the second subfield, but it may be applicable in the reset period of the remaining subfield to which the auxiliary reset waveform is applied.

As described above, the plasma display device and the driving method thereof according to embodiments of the present invention may produce the following effects. By including a timer or a temperature sensor, an amount of wall charges may be controlled at an end of the reset period by controlling the maintaining section of the falling ramp waveform in accordance with an operational time or a temperature of the plasma display device. Accordingly, the low discharge and/or misfiring may be reduced or prevented in subsequent address or sustain periods.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device driven by dividing one frame into a plurality of subfields, the plasma display device comprising:
a plasma display panel including a plurality of scan electrodes;
a scan electrode driver configured to apply a falling ramp waveform to scan electrodes in a reset period; and
a logic controller configured to control a maintaining section of the falling ramp waveform depending on an operational time or a temperature of the plasma display device.

2. The plasma display device as claimed in claim 1, wherein the logic controller is configured to increase the maintaining section of the falling ramp waveform as the operational time increases.

3. The plasma display device as claimed in claim 2, further comprising a timer connected to the logic controller, the timer configured to sense the operational time of the plasma display device and to transmit a control signal in accordance with the operational time of the plasma display device to the logic controller whenever the operational time of the plasma display device increases by a predetermined time.

4. The plasma display device as claimed in claim 3, wherein the logic controller is configured to increase the maintaining section of the falling ramp waveform by a same amount from a predetermined maintaining section of the falling ramp waveform for each predetermined time increase.

5. The plasma display device as claimed in claim 2, wherein the logic controller is configured to provide an upper limit above which a length of the maintaining section of the falling ramp waveform will not be increased, regardless of an increase in operational time by the predetermined time.

6. The plasma display device as claimed in claim 5, wherein the predetermined time is constant up to the upper limit.

7. The plasma display device as claimed in claim 2, wherein the logic controller is configured to increase the maintaining section of the falling ramp waveform applied to scan electrodes during the reset period of subfields that display a low gray scale among the plurality of subfields in accordance with the operational time of the plasma display device.

8. The plasma display device as claimed in claim 1, wherein the scan electrode driver is configured to:
apply a main reset waveform including a rising ramp waveform to scan electrodes during a reset period of a first subfield in the plurality of subfields, and
apply an auxiliary reset waveform including the falling ramp waveform to scan electrodes during reset period of remaining subfields.

9. The plasma display device as claimed in claim 1, wherein the logic controller is configured to decrease the maintaining section of the falling ramp waveform in accordance with an increase in temperature of the plasma display device.

10. The plasma display device as claimed in claim 9, further comprising a temperature sensor, connected to the logic controller, the temperature sensor configured to sense the temperature of the plasma display device and to transmit a control signal for the temperature of the plasma display device to the logic controller whenever the temperature of the plasma display device is increased by a predetermined temperature from an initial temperature.

11. The plasma display device as claimed in claim IO, wherein the logic controller is configured to provide a lower limit below which a length of the maintaining section of the falling ramp waveform will not be decreased, regardless of an increase in temperature.

12. The plasma display device as claimed in claim 11, wherein the predetermined temperature is constant up to the lower limit.

13. A method for driving the plasma display device including a plasma display panel having a plurality of scan electrodes, the plasma display device being driven by dividing one field into a plurality of subfields, the method comprising:
(a) sensing an operational time or a temperature of the plasma display device;
(b) controlling a maintaining section of a falling ramp waveform applied to the scan electrode during a reset period in accordance with the sensed operational time or temperature; and
(c) applying the falling ramp waveform to scan electrodes during the reset period.

14. The method for driving the plasma display device as claimed in claim 13, wherein sensing includes producing a control signal in accordance with the operational time of the plasma display device whenever the operational time of the plasma display device is increased by a predetermined time.

15. The method for driving the plasma display device as claimed in claim 14, wherein controlling includes increasing the maintaining section of the falling ramp waveform in accordance with the control signal.

16. The method for driving the plasma display device as claimed in claim 15, wherein controlling includes providing an upper limit above which the maintaining section of the falling ramp waveform will not be increased, regardless of increasing operational time.

17. The method for driving the plasma display device as claimed in claim 14, wherein controlling includes increasing the maintaining section of the falling ramp waveform in accordance with the operational time of the plasma display device in subfields that display a low gray scale in the plurality of subfields.

18. The method for driving the plasma display device as claimed in claim 13, wherein the applying comprises:
applying a main reset waveform including a rising ramp waveform to scan electrodes during a reset period of a first subfield of the plurality of subfields; and
applying the falling ramp waveform to scan electrodes during reset periods of remaining subfields.

19. The method for driving the plasma display device as claimed in claim 13, wherein sensing includes producing a control signal whenever the temperature of the plasma display device is increased by a predetermined temperature from an initial temperature.

20. The method for driving the plasma display device as claimed in claim 19, wherein controlling includes decreasing the maintaining section of the falling ramp waveform from a predetermined maintaining section of the falling ramp waveform in accordance with the control signal.

21. The method for driving the plasma display device as claimed in claim 20, wherein controlling includes providing a lower limit below which the maintaining section of the falling ramp waveform will not be decreased, regardless of increasing temperature.
